(19) United States
(12) Patent Application Publication
(10) Pub. No.: US 2011/0082664 A1
(43) Pub. Date: Apr. 7, 2011

(54) METHOD OF PREDICTING POSITION OF OBJECT

(75) Inventors: Polly Huang, Taipei City (TW); Yu-Jung Chen, Kaohsiung City (TW); I-Hei Wu, Yongkang City (TW); Seng-Yong Lau, Yonghe City (TW)

(73) Assignee: NATIONAL TAIWAN UNIVERSITY, Taipei (TW)

(21) Appl. No.: 12/609,598

(22) Filed: Oct. 30, 2009

(30) Foreign Application Priority Data
Oct. 6, 2009 (TW) 098133835

(51) Int. Cl. G06F 15/00

(52) U.S. Cl. 702/150

(57) ABSTRACT

A method of predicting a position of an object includes the steps of (1) providing a filter for tracking at least one object and obtaining a first position and a first speed of the object at a first time, (2) providing a first acceleration of the object at the filter at the first time, (3) setting a second time by the filter, and (4) outputting a second position of the object at the second time by the filter according to the first position, the first speed, the first acceleration, the first time and the second time, so as to provide a way of predicting a position of an object more accurately.

### CROSS-REFERENCE TO RELATED APPLICATIONS

This non-provisional application claims priority under 35 U.S.C. § 119(a) on Patent Application No(s). 098133835 filed in Taiwan, R.O.C. on 6 Oct. 2009, the entire contents of which are hereby incorporated by reference.

### FIELD OF THE INVENTION

The present invention relates to a method of predicting a position of an object, in particular to a method capable of predicting the position of an object more accurately.

### BACKGROUND OF THE INVENTION

In general, two main methods are used for predicting a position of an object. In one method, a received signal strength indicator (RSSI) is used for receiving a plurality of beacon signals, and the strength of each beacon signal is used for defining a signal range, and then the intersection of each signal range is used for locating the position of an object and predicting the position of the object. However, the received signal strength indicator (RSSI) has the drawbacks including unstable signals, noises, a multipath effect, and antenna positioning that may affect the accuracy of positioning the object and predicting the position of the object.

In another method, a particle filter uses a position and a speed of the object at a first time, a mobility model and a nonlinear Bayesian tracking model to predict the position and the speed of the object at a second time. However, the particle filter assumes the speed is a constant speed. If the object is moving at a high speed, the particle filter can predict the position and speed of the object accurately in a large mobility range, but the particle filter cannot predict the position and speed of the object accurately in a small mobility range. If the object is moving at a low speed, the particle filter can predict the position and speed of the object accurately in a small mobility range, but the particle filter cannot predict the position and speed of the object accurately in a large mobility range.

Therefore, finding a way of predicting the position of an object more accurately is the main subject of the present invention.

### SUMMARY OF THE INVENTION

In view of the aforementioned shortcomings of the conventional manufacturing machine, the inventor of the present invention based on years of experience in the related industry to conduct extensive researches and experiments, and finally invented a method of predicting a position of an object more accurately.

Therefore, it is a primary objective of the present invention to provide a method of predicting a position of an object, wherein an acceleration value and an acceleration direction of the object at a first time are used for predicting the position of the object at a second time to achieve the effect of predicting the position of the object more accurately.

To achieve the foregoing objective, the present invention discloses a method of predicting a position of an object in accordance with a first preferred embodiment, and the method comprises the steps of: (1) providing a filter, for tracking at least one object, and obtaining a first position and a first speed of the object at a first time; (2) providing a first acceleration of the object at the filter at the first time; (3) setting a second time by the filter; and (4) outputting a second position of the object at the second time by the filter according to the first position, the first speed, the first acceleration, the first time and the second time.

The aforementioned first acceleration is measured by an accelerometer.

The aforementioned filter is a particle filter or a Bayesian filter.

The present invention also discloses a method of predicting a position of an object in accordance with a second preferred embodiment, and the method comprises the steps of: (1)′ providing a filter, for tracking at least one object, and obtaining a first position of the object at a first time; (2)′ providing a first moving direction of the object at the first time at the filter; (3)′ setting a moving interval by the filter; (4)′ generating a second time by the filter, after the object has moved along a moving interval; and (5)′ outputting a second position of the object at the second time by the filter according to the first position, the moving interval and the first moving direction.

The aforementioned moving direction is measured by an accelerometer.

The aforementioned filter is a particle filter or a Bayesian filter.

The method of the present invention can predict the position of an object more accurately.

### BRIEF DESCRIPTION OF THE DRAWINGS

FIG. 1 is a flow chart of a first preferred embodiment of the present invention; and

FIG. 2 is a flow chart of a second preferred embodiment of the present invention.

### DESCRIPTION OF THE PREFERRED EMBODIMENTS

Other features and advantages of the present invention will become apparent in the following detailed description of the preferred embodiments with reference to the accompanying drawings.

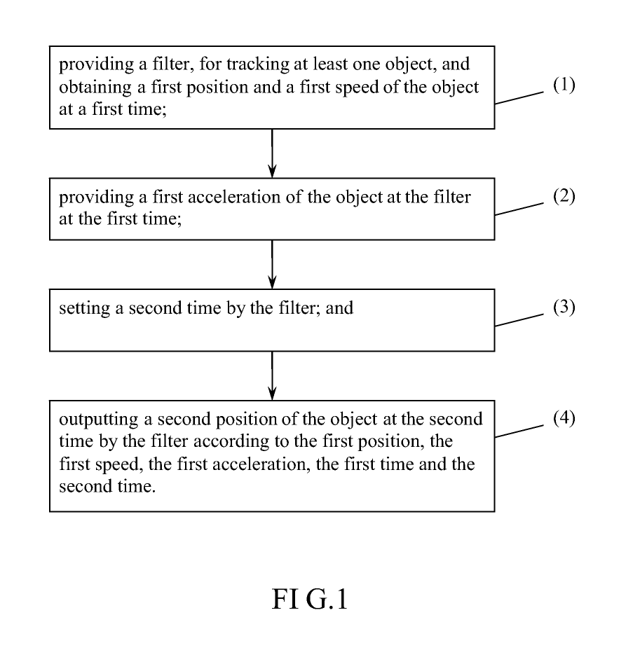

With reference to FIG. 1 for a flow chart of a first preferred embodiment of the present invention, a method of predicting a position of an object in accordance with this embodiment comprises the steps of:

(1) providing a filter for tracking at least one object, and obtaining a first position and a first speed of the object at a first time, wherein the filter can be a particle filter or a Bayesian filter, and the first speed is measured by a speedometer;

(2) providing a first acceleration of the object at the filter at the first time, wherein the first acceleration is measured by an accelerometer;

(3) setting a second time by the filter; and

(4) outputting a second position of the object at the second time by the filter according to the first position, the first speed, the first acceleration, the first time and the second time, wherein a time difference of the first time and the second time is calculated first, and then the time difference is used together with the first speed and the first acceleration to calculate a displacement of the object, and finally the displacement and the first position are used to output a second position of the object at the second time.

The aforementioned first speed and first acceleration include a speed value and an acceleration value as well as a speed direction and an acceleration direction. Therefore, the foregoing method of the invention can predict the second position of the object at the second time as well as the displacement direction of the object at the first time.

The higher the moving speed of the object, the greater is the motion inertia of the object. The object moving at a high speed will not change its moving direction easily during a moving process, such that if a longer second time is set, then a more accurate prediction of the second position of the object can still be predicted. The lower the moving speed of the object, the smaller is the motion inertia of the object the object. The object moving at a low speed will change its moving direction easily during a moving process, such that if a shorter second time is set, a more accurate second position of the object can be predicted.

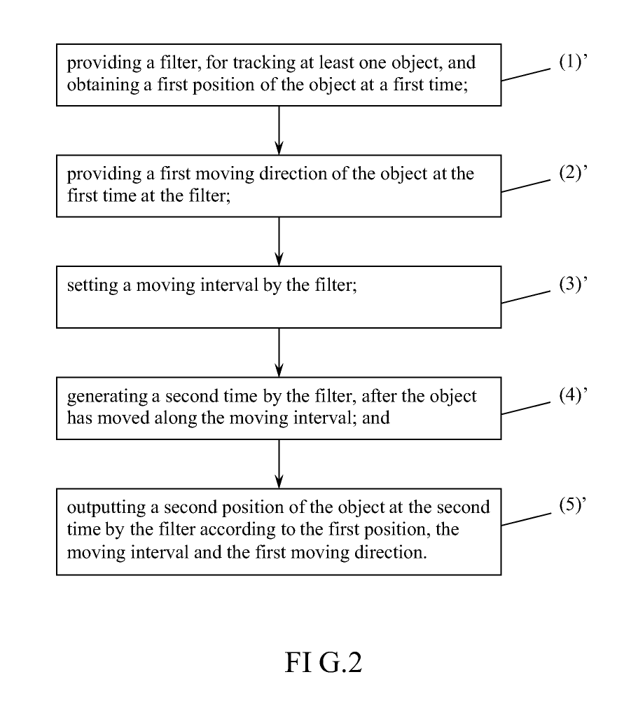

With reference to FIG. 2 for a flow chart in accordance with a second preferred embodiment of the present invention, a method of predicting a position of an object of this embodiment comprises the steps of:

(1)′ providing a filter for tracking at least one object, and obtaining a first position and a first speed of the object at a first time, wherein the filter can be a particle filter or a Bayesian filter;

(2)′ providing a first moving direction of the object at the filter at the first time, wherein the first moving direction is measured by an accelerometer;

(3)′ setting a moving interval by the filter;

(4)′ generating a second time by the filter, after the object has moved along the moving interval; and

(5)′ outputting a second position of the object at the second time by the filter according to the first position, the moving interval and the first moving direction.

The aforementioned first moving direction can be measured by an accelerometer, wherein the accelerometer can measure an acceleration value of the object as well as an acceleration direction of the object.

The higher the moving speed of the object, the greater is the motion inertia of the object. The object moving at a high speed will not change its moving direction easily during a moving process, such that if a larger moving interval is set, then the second position of the object can still be predicted more accurately. The lower the moving speed of the object, the smaller is the motion inertia of the object. The object moving at a low speed will change its moving direction easily during a moving process, such that if a smaller moving interval is set, then the second position of the object can be predicted more accurately.

The present invention predicts the position of the object at the second time by the acceleration value and direction of the object at the first time in order to achieve the effect of predicting the position of the object more accurately. Obviously, products produced by using the present invention can meet the market requirements.

In summation of the description above, the present invention provides a feasible design and complies with patent application requirements, and thus is duly filed for patent application.

While the invention has been described by means of specific embodiments, numerous modifications and variations could be made thereto by those skilled in the art without departing from the scope and spirit of the invention set forth in the claims.

What is claimed is:

1. A method of predicting a position of an object, comprising the steps of:
(1) providing a filter, for tracking at least one object, and obtaining a first position and a first speed of the object at a first time;
(2) providing a first acceleration of the object at the filter at the first time;
(3) setting a second time by the filter; and
(4) outputting a second position of the object at the second time by the filter according to the first position, the first speed, the first acceleration, the first time and the second time.

2. The method of claim 1, wherein the first acceleration is measured by an accelerometer.

3. The method of claim 1, wherein the filter is a particle filter or a Bayesian filter.

4. The method of claim 2, wherein the filter is a particle filter or a Bayesian filter.

5. A method of predicting a position of an object, comprising the steps of:
(1)′ providing a filter, for tracking at least one object, and obtaining a first position of the object at a first time;
(2)′ providing a first moving direction of the object at the first time at the filter;
(3)′ setting a moving interval by the filter;
(4)′ generating a second time by the filter, after the object has moved along the moving interval; and
(5)′ outputting a second position of the object at the second time by the filter according to the first position, the moving interval and the first moving direction.

6. The method of claim 5, wherein the first moving direction is measured by an accelerometer.

7. The method of claim 5, wherein the filter is a particle filter or a Bayesian filter.

8. The method of claim 6, wherein the filter is a particle filter or a Bayesian filter.
